(19) United States
(12) Patent Application Publication
(10) Pub. No.: US 2018/0365914 A1
(43) Pub. Date: Dec. 20, 2018

(54) Door Access Control System Through Identifiable Data Transmission And Method Thereof

(71) Applicants: Inventec (Pudong) Technology Corporation, Shanghai (CN); Inventec Corporation, Taipei City (TW)

(72) Inventor: Chaucer Chiu, Taipei (TW)

(21) Appl. No.: 15/623,038

(22) Filed: Jun. 14, 2017

(30) Foreign Application Priority Data
Dec. 21, 2016 (CN) 201611190440.3

(51) Int. Cl. G07C 9/00; G06K 7/14

(52) U.S. Cl. CPC G07C 9/00007; G06K 7/1413

(57) ABSTRACT

The present disclosure illustrates a door access control system through identifiable data transmission and a method thereof. In the door access control system, personally identifiable data is directly transmitted from a portable device to a server, an authentication barcode indirectly obtained through a reader device is also transmitted to the server, and the server then determines whether the personally identifiable data matches the authentication barcode, and generates a management signal upon a determination result, and the management signal is transmitted to a management device for opening a controlled door. As a result, the system and the method can prevent a problem that a user is unable to pass through a controlled door when losing access card for door access control, and can achieve the effect of improving the security of door access control system.

### CROSS-REFERENCE TO RELATED APPLICATION

This application claims the benefit of Chinese Patent Application No. 201611190440.3, filed Dec. 21, 2016.

### BACKGROUND OF THE INVENTION

### Field of the Invention

The present disclosure relates to a door access control system and a method thereof, more particularly to a door access control system which transmits identifiable data for opening a controlled door, and a method thereof.

### Description of the Related Art

Conventional door locks, which are most common door access control devices, have advantages of simple and easy installation and no electricity required; furthermore, even if the key of the locked door is lost, the user may find a locksmith to open the door lock. However, the key of the door lock may be lost easily, and the conventional door lock is also hard to stop experienced thief.

In order to prevent the trouble of losing key and increase difficulty for thieves to open the door lock, electronic locks are developed and gradually popularized with progress of electronic technology, more particularly, the places (such as residences or offices) where many people come in and out are almost installed with the electronic locks. Electronic locks may be classified into keypad lock, IC lock, and magnetic-card lock. The keypad lock has advantages of without carrying key and without worrying about losing key, but the keypad lock is expensive and has poor performance in confidentiality, and the user's password is easy to be skimmed or peeped by thieves. For this reason, the door access control system using the keypad lock may have a certain degree of a risk in being passed illegally. IC lock and magnetic card lock have better performance in confidentiality, but their common drawback is that the user is unable to pass the door access control system when losing IC card or magnetic card, and the internal password of the IC lock or magnetic card lock must be changed after the IC card or magnetic card is lost, which causes that other card holders also have to change their owned cards, otherwise they are unable to pass the door access control system, and which troubles the other card holders.

Therefore, what is need is to develop a door access control system to solve the problem that the user is unable to pass the card-type door access control system when losing the IC card or magnetic card.

### SUMMARY OF THE INVENTION

In order to solve the problem that the user is unable to pass the controlled door when losing the IC card or magnetic card for the door access control, the present disclosure is to provide a door access control system and a method thereof.

According to an embodiment, the present disclosure provides a door access control system through identifiable data transmission, and the door access control system includes a portable device, a reader device, a server and a management device. The portable device is configured to obtain an authentication barcode. The server is configured to receive personally identifiable data transmitted from the portable device, and transmit a control message to the reader device, to enable the reader device to obtain an authentication barcode through the portable device and transmit the authentication barcode to the server. When the server determines that the personally identifiable data matches the authentication barcode, the server generates a management signal. The management device is configured to open a controlled door upon receipt of the management signal.

According to an embodiment, the present disclosure provides a door access control method through identifiable data transmission, and the door access control method includes following steps: generating an authentication barcode by a server; obtaining the authentication barcode by a portable device; transmitting personally identifiable data from the portable device to the server; transmitting a control message from the server to a reader device, to enable the reader device to obtain the authentication barcode from the portable device; transmitting the authentication barcode from the reader device to the server; transmitting a management signal to a management device when the server determines that the personally identifiable data matches the authentication barcode; and opening, by the management device, a controlled door.

According to aforementioned content, the difference between the present disclosure and the conventional technology is that the door access control system and method thereof of the present disclosure use the portable device to directly transmit the personally identifiable data to the server, and use the reader device to indirectly transmit the authentication barcode to the server, and the server determines whether the personally identifiable data transmitted from the portable device matches the authentication barcode transmitted from the reader device, and generates the management signal according to the determination result, and then transmits the management signal to the management device to open the controlled door. By using aforementioned technical means, the door access control system and method thereof of the present disclosure may solve the conventional technology problem and achieve the technical effect of improving safety of the door access control system.

### BRIEF DESCRIPTION OF THE DRAWINGS

The structure, operating principle and effects of the present disclosure will be described in detail by way of various embodiments which are illustrated in the accompanying drawings.

FIG. 1 is a framework diagram of a door access control system of the present disclosure.

FIG. 2A is a flowchart showing the steps in an operation of a door access control method of the present disclosure.

FIG. 2B is a flowchart showing the steps in an operation of an additional method of transmitting an announcement message, in accordance with the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

In the door access control system and the method thereof of the present disclosure, the user may operate a portable device to communicate with a server and a reader device of the door access control system, and a controlled door is then opened after the server authenticates identifiable data from the owner's portable device, so that the user is not necessarily to use key or access card for passing the door access control system.

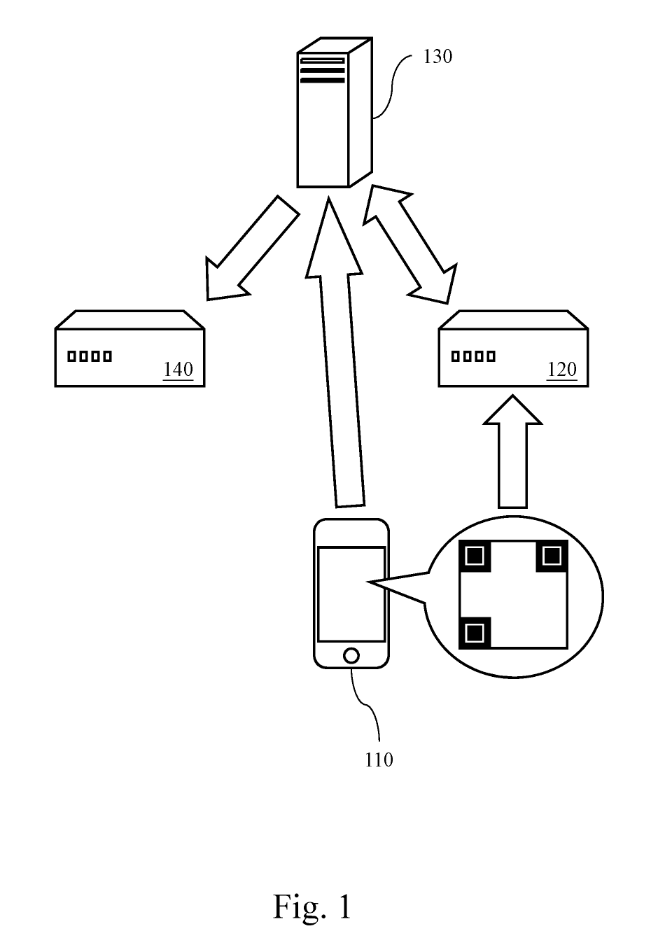

The following refer to FIG. 1, which is a framework diagram showing an operation of a system which transmits identifiable data for door access control, in accordance with the present disclosure. As shown in FIG. 1, the system of the present disclosure may include a portable device 110, a reader device 120, a server 130 and a management device 140. Preferably, there may be multiple reader devices 120 in the system, that is, the system of the present disclosure may include one or more reader device 120.

The portable device 110 is communicated with the server 130, and configured to display data or transmit data to a near-end device. The portable device 110 may be, but not limited to, a cell phone, a tablet computer, a notebook computer and so on.

The portable device 110 is used to obtain an authentication barcode. The authentication barcode may be a linear bar code or a two-dimensional barcode, but the present disclosure is not limited to the form of the authentication barcode. The portable device 110 is not necessarily unique for the authentication barcode, for example, different portable device 110 may obtain the same authentication barcode at the same time. Furthermore, in other embodiment, the portable device 110 may obtain a one-time-use authentication barcode; in other words, the portable device 110 must obtain different authentication barcode for every use.

The portable device 110 may read the authentication barcode from storage media thereof (not shown in FIG. 1), but the present disclosure is not limited thereto. The portable device 110 may be linked to a specific network storage space, such as an email box or a network hard drive, to download the authentication barcode therefrom. For example, the portable device 110 may obtain the authentication barcode from a multimedia short message service (SMS) or an email transmitted from the server 130.

In other embodiment, when the server 130 has authenticated the portable device 110, the portable device 110 may be linked to the server 130 to download the authentication barcode therefrom. For example, the portable device 110 may transmit identifiable data, upon which the server 130 may identify the portable device 110, to the server 130, and after the server 130 confirms the identifiable data, the portable device 110 is permitted to download the authentication barcode from the server 130. However, aforementioned content is merely for exemplary illustration and the manner of authenticating the portable device 110 by the server 130 is not limited thereto. The identifiable data of the portable device 110 may be a device number or a telephone number of the portable device 110, or other data representative of the portable device 110 or an owner of the portable device 110; however, the present disclosure not limited thereto.

The portable device 110 also transmits personally identifiable data to the server 130. Preferably, the personally identifiable data may be any combination of various numbers of letters or numbers, and correspond to the owner of the portable device 110, that is, the personally identifiable data may be representative of the owner of the portable device 110, for example, the personally identifiable data may be the identifiable data of the portable device 110, or an account/password of the owner of the portable device 110 for the server 130.

The portable device 110 may be linked to the server 130 by telephone network, mobile communication network, or wireless network, to transmit data or signal to the server 130 or receive data or signal from the server 130; however, the present disclosure is not limited thereto. For example, a cellphone number of the portable device 110 may be the personally identifiable data, and the portable device 110 may call the server 130 or transmit SMS to the server 130, so that the cellphone number is also transmitted with the telephone signal or SMS to the server 130. Alternatively, the portable device 110 may make a call to the server 130 through telephone network or mobile communication network, or by using wireless network and a dial-up application (APP), to transmit the personally identifiable data to the server 130 through an interactive voice response (IVR) provided by the server 130 in the call. The portable device 110 may be directly linked to the server 130 through the mobile communication network or the wireless network, to transmit the personally identifiable data to the server 130 through the internet network.

Furthermore, the portable device 110 may also transmit device identifiable data of the reader device 120 to the server 130. Generally speaking, the portable device 110 may transmit the device identifiable data of the reader device 120 during the same interconnection for transmitting of the personally identifiable data. The device identifiable data of the reader device 120 is usually inputted into the portable device 110 by the owner of the portable device 110, but the present disclosure is not limited thereto. For example, the portable device 110 may capture and recognize the device identifiable data of the reader device 120 through an image capture unit and an image recognition unit thereof. The device identifiable data of the reader device 120 will be illustrated later.

The portable device 110 may receive and display an error message transmitted from the server 130. Generally speaking, the error message received by the portable device 110 from the server 130 may also indicate the reason why the server 130 may not or fails to open the controlled door. The error message received by the portable device 110 may be formed by any combination of various numbers of characters including text, number or symbol, that is, the error message received by the portable device 110 may be an error code or a text description.

For example, the portable device 110 may receive a SMS containing the error message; or receive a voice, which contains the error message, through the IVR provided by the server 130; or receive data, which contains the error message, transmitted from the server 130 through internet network.

The portable device 110 may also receive the announcement message transmitted from the server 130, and then open and display the received announcement message for the owner of the portable device 110 to read. When the portable device 110 opens the received announcement message, the portable device 110 may transmit a notice message to the server 130 to acknowledge the server 130 that the announcement message is read by the owner of the portable device 110.

The reader device 120 is linked with the server 130, for example, through a connection wire, such as a signal wire or power wire, or through internet network or telephone network; however, in the present disclosure, the manner of linking the reader device 120 and the server 130 is not limited thereto.

Generally speaking, the reader device 120 may be placed near the controlled door of the present disclosure within a certain distance; however, the present disclosure is not limited thereto. In some embodiments, the reader device 120 may have the device identifiable data, or correspond to the device identifiable data, and the device identifiable data of the reader device 120, or the device identifiable data corresponding to the reader device 120, may be labelled on the reader device 120 or vicinity of the reader device 120. Each piece of device identifiable data may represent a specific reader device 120, that is, different reader device 120 usually has different device identifiable data, or corresponds to different device identifiable data. The device identifiable data may be formed by any combination of various numbers of characters including letter or number.

The reader device 120 is used to obtain the authentication barcode through the portable device 110. The reader device 120 may use an image capture unit thereof (not shown in figures) to capture the authentication barcode displayed on the display screen of the portable device 110; or receive the authentication barcode transmitted from the portable device 110 through wireless communication technology such as Bluetooth or Near Field Communication (NFC); however, the manner that the reader device 120 obtains the authentication barcode through the portable device 110 is not limited to aforementioned examples.

The reader device 120 is also used to receive a control message transmitted from the server 130, and transmit the obtained authentication barcode to the server 130. The control message received by the reader device 120 may be in the form of data or signal, but the present disclosure is not limited thereto, and any manner of enabling the reader device 120 to transmit the authentication barcode, which is obtained through the portable device 110, to the server 130 is covered by the spirit and scope of the present disclosure set forth in the claims.

After receiving the control message transmitted from the server 130, the reader device 120 obtains the authentication barcode through the portable device 110 and then transmits the authentication barcode to the server 130. Alternatively, the reader device 120 may obtain the authentication barcode through the portable device 110 before receiving the control message transmitted from the server 130, and after receiving the control message, the reader device 120 transmits the authentication barcode to the server 130.

The server 130 may receive the personally identifiable data transmitted from the portable device 110. The server 130 may be linked with the portable device 110 through telephone network, mobile communication network or wireless network, to transmit data or signal to the portable device 110 or receive data or signal transmitted from the portable device 110; however, the present disclosure is not limited thereto.

In some embodiments, after receiving the personally identifiable data, the server 130 authenticates the received personally identifiable data, and when the received personally identifiable data does not pass the authentication, the server 30 ignores the received personally identifiable data, that is, the server 30 behaves as if the server 130 did not receive the personally identifiable data. For example, the server 130 may search the received personally identifiable data in a whitelist set in advance, and when the received personally identifiable data is found in the whitelist, it indicates that the received personally identifiable data is authorized; otherwise, the received personally identifiable data is not authorized.

The server 130 also receives the personally identifiable data from the portable device 110, and then transmits the control message to the reader device 120. In other embodiment, the server 130 may be linked with a plurality of reader devices 120, and the server 130 may receive the device identifiable data of the reader device 120 transmitted from the portable device 110, and transmit the control message to the reader device which has received device identifiable data or corresponds to the received device identifiable data.

The server 130 also receives the authentication barcode transmitted from the reader device 120, and then determines whether the received personally identifiable data matches the received authentication barcode. Generally speaking, the server 130 may store correspondence data in advance and check whether a record matching both of the received personally identifiable data and the received authentication barcode exists in the correspondence data. For example, the server 130 may find all records matching the received personally identifiable data, from the correspondence data built first, and then check whether any one of the found records matches the received authentication barcode. When the record matching both of the received personally identifiable data and the received authentication barcode exists, it indicates that the received personally identifiable data matches the received authentication barcode; otherwise, when the record matching both of the received personally identifiable data and the authentication barcode do not exist in the correspondence data, it indicates that the received personally identifiable data does not match the received authentication barcode. However, the manner that the server 130 determines whether the received personally identifiable data matches the received authentication barcode is not limited to aforementioned example.

When the received personally identifiable data does not match the received authentication barcode, the server 130 generates the error message and transmits the error message to the portable device 110, or the server 130 may not perform any further action. Except that the server 130 does not transmit the management signal to the management device 140, the present disclosure does not limit the response of the server 130 after the server 130 determines that the received personally identifiable data does not match the received authentication barcode. Aforementioned management signal may be in the form of signal or data, but the present disclosure is not limited thereto, and any manner of representing that the controlled door may be opened is covered by the spirit and scope of the present disclosure set forth in the claims.

When it is determined that the received personally identifiable data matches the received authentication barcode, the server 130 generates the management signal and transmits the management signal to the management device 140. The server 130 may be linked with the management device 140 through the connection wire such as the signal wire or power wire, or through internet network or telephone network, but the manner of linking the server 130 and the management device 140 is not limited thereto.

In other embodiment, every time the server 130 determines that the received personally identifiable data matches the received authentication barcode, the server 130 may generate a new authentication barcode corresponding to the received personally identifiable data, and transmit the new authentication barcode to the portable device 110. At the same time, the server 130 may also update the correspondence data which is used to determine whether the received personally identifiable data matches the received authentication barcode.

The server 130 may also transmit the announcement message to the portable device 110. Generally speaking, the announcement message transmitted by the server 130 is formed by any combination of various numbers of characters including text, letter, number, or symbol. The announcement message is usually inputted to the server 130 or uploaded to the server 130 by a supervisor of the server 130, but the present disclosure is not limited thereto.

In some embodiments, the server 130 may also determine whether the portable device 110 has been turned on and displayed the announcement message, and then generate and transmit the management signal to the management device 140 after determining that the portable device 110 has been turned on and displayed the announcement message. Generally speaking, the server 130 may receive the notice message transmitted from the portable device 110 after the portable device 110 has been turned on and displayed the announcement message, and after receiving the notice message from the portable device 110, the server 130 may determine that the portable device 110 has been turned on and displayed the announcement message.

Upon receipt of the management signal transmitted from the server 130, the management device 140 opens the controlled door. Generally speaking, the management device 140 is usually placed near the controlled door of the present disclosure within a certain distance, and the management device 140 is usually electrically coupled to the controlled door through an electric wire, but the present disclosure is not limited thereto.

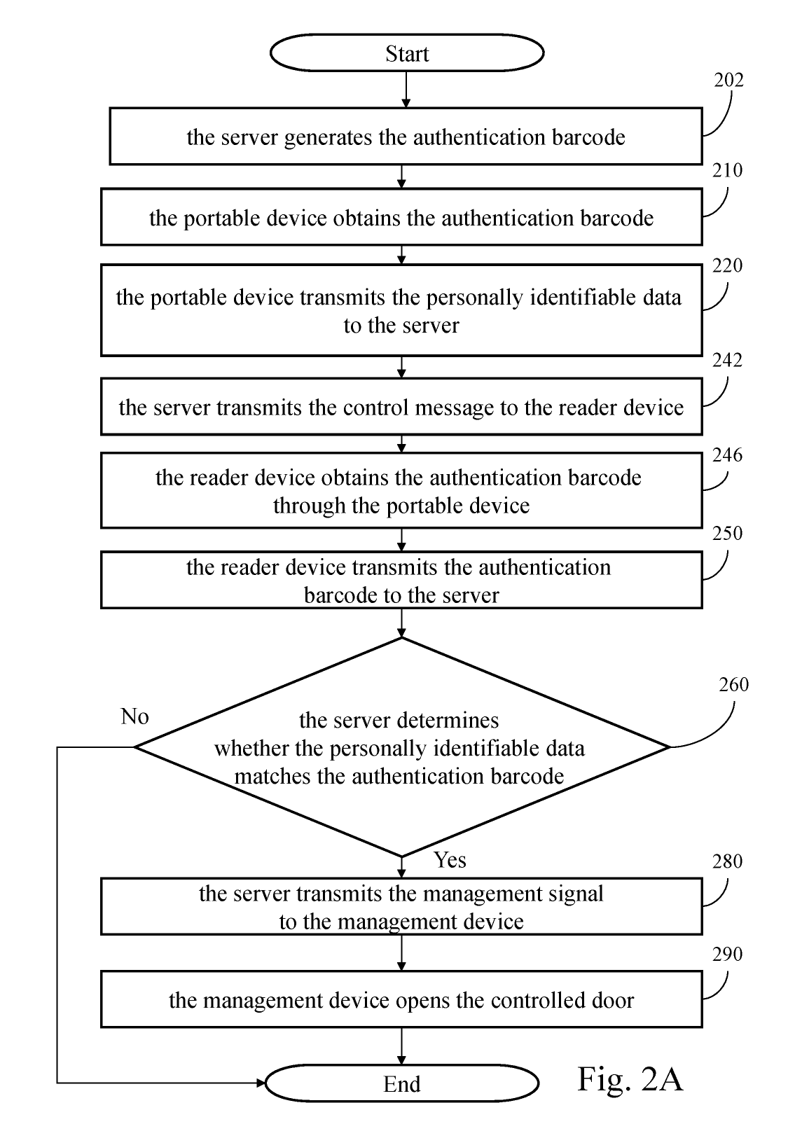

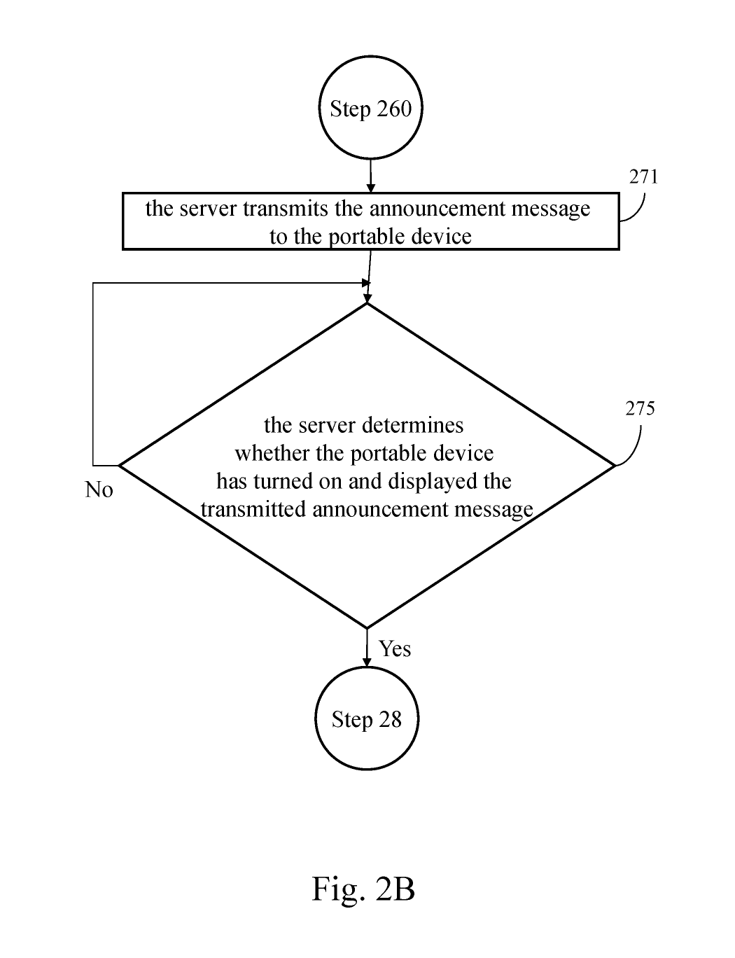

The following refers to a first embodiment for illustration of the system and method thereof of the present disclosure. FIG. 2A is a flowchart showing the steps in an operation of the method of transmitting identifiable data for door access control, in accordance with the present disclosure. In this embodiment, suppose that the portable device 110 is a smartphone, but the present disclosure is not limited thereto.

When a user goes to the front of the door controlled by the door access control system of the present disclosure, the user may operate the portable device 110 to obtain the authentication barcode generated by the server 130 (through steps 202 and 210). In this embodiment, suppose that the user has operated the portable device 110 or other device to link the server 130, pass identification authentication and log in the user's email account, and the server 130 has loaded the user's pre-registered email account, and emailed the generated authentication barcode to the user's email server; the user has operated the portable device 110 to link to the email server to download the email sent from the server 130, and obtain the authentication barcode contained in the email downloaded from the email server.

In practical application, before using the door access control system of the present disclosure, the user may operate the portable device 110 in advance to obtain the authentication barcode; for example, after the user pass the door access control system to get home, the user may operate the portable device 110 to obtain the authentication barcode for next use; however, the present disclosure is not limited to aforementioned example.

In a step 220, after the portable device 110 obtains the authentication barcode (in the step 210), the portable device 110 may transmit the personally identifiable data to the server 130. In this embodiment, suppose that the personally identifiable data is a telephone number of the portable device 110, the user may operate the portable device 110 to make a call to the IVR provided by the server 130, so that the server 130 may obtain the telephone number of the portable device 110 based on a telephone ringing signal received by the IVR, and connect the call.

In a step 242, after the server 130 obtains the personally identifiable data transmitted from the portable device 110, the server 130 may generate the control message and transmit the control message to the reader device 120. In this embodiment, after the server 130 transmits the control message to the reader device 120, the server 130 may remind the user, through the IVR, to operate the portable device 110 to provide the authentication barcode to the reader device 120. Under a condition that the server 130 is linked to a plurality of reader devices 120, after the call is connected, the IVR of the server 130 may prompt the user to input the device identifiable data of the reader device 120. After the user inputs the device identifiable data labeled on a panel of the reader device 120 into the portable device 110, so that the portable device 110 may transmit the device identifiable data of the reader device 120 to the server 130 through the IVR. As a result, the server 130 may transmit the control message to the reader device 120 corresponding to the device identifiable data received by the server 130.

In practical application, under a condition that the server 130 stores an identity correspondence table for management, after receiving the personally identifiable data transmitted from the portable device 110, the server 130 determines whether the received personally identifiable data exists in the identity correspondence table, if yes, the server 130 generates and transmits the control message to the reader device 120; if the server 130 determines that the received personally identifiable data does not exist in the identity correspondence table, the server may prompt the user, through the IVR, that the personally identifiable data is incorrect, or the server 130 does not generate the control message, or the server 130 does not transmit any message to the reader device 120.

In a step 246, after the reader device 120 receives the control message transmitted from the server 130, the reader device 120 obtains the authentication barcode through the portable device 110. In a step 250, the reader device 120 may transmit the authentication barcode to the server 130. In this embodiment, the user may operate the portable device 110 to display the authentication barcode on a screen thereof, and move the portable device 110 to the front of a camera disposed on the panel of the reader device 120, so that the reader device 120 may capture the authentication barcode displayed on the portable device 110.

In a step 260, after the server 130 receives the authentication barcode transmitted from the reader device 120, the server 130 may determine whether the personally identifiable data received from the portable device 110 matches the authentication barcode received from the reader device 120. In this embodiment, from the identity correspondence table, the server 130 may search a record including both of the personally identifiable data received from the portable device 110 and the authentication barcode received from the reader device 120. If the server 130 does not find such record in the identity correspondence table, it indicates that the personally identifiable data received from the portable device 110 does not match the authentication barcode received from the reader device 120, and the server 130 may generate the error message and transmit the error message to the portable device 110, that is, the server 130 prompt the error message to the user through the IVR.

In a step 280, when the server 130 finds, in the identity correspondence table, the record including both of the received personally identifiable data and the received authentication barcode, it indicates that the personally identifiable data received from the portable device 110 matches the authentication barcode received from the reader device 120, and the server 130 may generate the management signal and transmit the management signal to the management device 140. In a step 290, upon receipt of the management signal from the server 130, the management device 140 may open the controlled door. Therefore, according the door access control system of the present disclosure, the user may operate the portable device 110 (such as a carry-on cell phone) to open the controlled door without using key or access card. Furthermore, the portable device 110 uses the authentication barcode generated by the server 130 to open the controlled door, so obviously it is safer than usage of the key or access card which may be copied.

The following refers to a second embodiment for illustration of the system and method of the present disclosure. Please also refer back to FIG. 2A. In the second embodiment, the portable device 110 is also the smartphone.

In the step 202 or step 210, when the user goes to the front of the door controlled by the door access control system of the present disclosure, the user may operate the portable device 110 to obtain the authentication barcode generated by the server 130. In this embodiment, suppose that the user may operate the portable device 110 to link the server 130, and download the authentication barcode from the server 130 after inputting the account and password to login the server 130.

In the step 220, after the portable device 110 obtains the authentication barcode (in the step 210), the portable device 110 may transmit the personally identifiable data to the server 130. In this embodiment, under a condition that the server 130 manages the identity correspondence table, the user may operate the portable device 110 to make a call to the IVR provided by the server 130, and the IVR then connects the call, and after the server 130 determines that the telephone number of the portable device 110 does not exist in the identity correspondence table of the server 130, the IVR may prompt the user to operate the portable device 110 to input the personally identifiable data, and the portable device 110 then transmits the personally identifiable data inputted by the user to the IVR provided by the server 130.

In the step 242, after the server 130 obtains the personally identifiable data transmitted from the portable device 110, the server 130 may determine whether the received personally identifiable data exists in the identity correspondence table, if yes, the server 130 may generate the control message and transmit the control message to the reader device 120, and prompt the user, through IVR, to operate the portable device 110 to provide the authentication barcode to the reader device 120. When the server 130 determines that the received personally identifiable data does not exist in the identity correspondence table, the server 130 may prompt the user, through the IVR, that the personally identifiable data is incorrect, and prompt the user to input the personally identifiable data again or hang up the phone.

In the step 246, after the reader device 120 receives the control message transmitted from the server 130, the reader device 120 obtains the authentication barcode through the portable device 110. In the step 250, the reader device 120 transmits the authentication barcode to the server 130. In this embodiment, the user may operate the portable device 110 to transmit the authentication barcode to the reader device 120 through NFC.

In the step 260, after the server 130 receives the authentication barcode transmitted from the reader device 120, the server 130 may determine whether the personally identifiable data received from the portable device 110 matches the authentication barcode received from the reader device 120. In this embodiment, from the identity correspondence table, the server 130 may search the record including both of the personally identifiable data received from the portable device 110 and the authentication barcode received from the reader device 120.

In the step 280, after the server 130 finds, in the identity correspondence table, the record including both of the received personally identifiable data and the receives authentication barcode, the server 130 may determine that the personally identifiable data received from the portable device 110 matches the authentication barcode received from the reader device 120, and then generate the management signal and transmit the management signal to the management device 140. Upon receipt of the management signal from the server 130, the management device 140 opens the controlled door. As a result, according to the embodiment of the present disclosure, even if the user does not carry self-owned portable devices (such as the cellphones), the user may operate other person's portable device to open the controlled door. Furthermore, only after the portable device 110 passes authentication of the server 130, the portable device 110 may use the authentication barcode provided by the server 130 to open the controlled door, so the door access control system and method thereof of the present disclosure is safer than other door access control system using key or access card which cannot be authenticated.

In the first embodiment and the second embodiment, after the server 130 determines that the personally identifiable data received from the portable device 110 matches the authentication barcode received from the reader device 120 (in the step 260), the server 130 may transmit the announcement message to the portable device 110 (in a step 271), as shown in FIG. 2B, and then determines whether the portable device 110 has turned on and displayed the transmitted announcement message (in a step 275). In this embodiment, after the portable device 110 has turned on and displayed the announcement message received from the server 130, the portable device 110 transmits the notice message to the server 130, and after the server 130 receives the notice message transmitted from the portable device 110, the server 130 determines that the portable device 110 has turned on and display the transmitted announcement message, and generates management message, and transmits the management message to the management device 140 (in the step 280).

Furthermore, in the first embodiment and the second embodiment, after the server 130 determines that the personally identifiable data received from the portable device 110 matches the authentication barcode received from the reader device 120, the server 130 may generate a new authentication barcode, and email the new authentication barcode to the user's email server, so that the user may link the portable device 110 with the email server to download the email transmitted from the server 130, and then obtain the new authentication barcode attached in the downloaded email; alternatively, the user may operate the portable device 110 to link the server 130, and after the user successfully logins in the server 130, the user may download the new authentication barcode generated by the server 130. In other words, the new authentication barcode generated by the server 130 may be a one-time-use authentication barcode, thereby further improving safety of the door access control system of the present disclosure.

To summarize, the difference between the present disclosure and the conventional technology is that the door access control system and the method thereof of the present disclosure use the portable device to directly transmit the personally identifiable data to the server, and use the reader device to indirectly transmit the authentication barcode to the server, and the server determines whether the personally identifiable data transmitted from the portable device matches the authentication barcode transmitted from the reader device, and generates the management signal according to the determination result, and then transmits the management signal to the management device to open the controlled door. By using aforementioned technical means, the door access control system and method thereof of the present disclosure may solve the conventional technology problem that the user may not pass through the conventional door access control system if the user's access card is lost, and further achieve the technical effect of improving safety of the door access control system.

Furthermore, the door access control system and method thereof through identifiable data transmission may be implemented by hardware, software or combination thereof, or be implemented by centralized computing in a computer system or by distributed computing in different components located in some interconnected computer systems.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A door access control method through identifiable data transmission, comprising:
generating an authentication barcode by a server;
obtaining the authentication barcode by a portable device;
transmitting personally identifiable data from the portable device to the server;
transmitting a control message from the server to a reader device, to enable the reader device to obtain the authentication barcode from the portable device;
transmitting the authentication barcode from the reader device to the server;
transmitting a management signal to a management device when the server determines that personally identifiable data matches the authentication barcode; and
opening a controlled door by the management device.

2. The door access control method according to claim 1, wherein the step of enabling the reader device to obtain the authentication barcode from the portable device further comprises: using the reader device to capture the authentication barcode displayed on the portable device, or receive the authentication barcode transmitted from the portable device through wireless communication technology.

3. The door access control method according to claim 1, wherein the step of transmitting the personally identifiable data from the portable device to the server comprises:
making a call from the portable device to the server, to enable the server to set a cellphone number of the portable device as the personally identifiable data, or after the portable device makes the call to the server, transmitting the personally identifiable data to the server through an interactive voice response provided by the server.

4. The door access control method according to claim 1, prior to the step of transmitting the control message from the server to the reader device, further comprising:
transmitting device identifiable data of the reader device from the portable device to the server.

5. The door access control method according to claim 1, prior to the step of transmitting the management signal from the server to the management device, further comprising:
transmitting an announcement message from the server to the portable device, and the server determining whether the portable device is turned on and displays the announcement message.

6. A door access control system through identifiable data transmission, comprising:
a portable device configured to obtain an authentication barcode;
a reader device;
a server configured to receive personally identifiable data transmitted from the portable device, and transmit a control message to the reader device, to enable the reader device to obtain an authentication barcode through the portable device and transmit the authentication barcode to the server, wherein after the server determines that the personally identifiable data matches the authentication barcode, the server generates a management signal; and
a management device configured to open a controlled door upon receipt of the management signal.

7. The door access control system according to claim 6, wherein the reader device captures the authentication barcode displayed on the portable device, or receives the authentication barcode transmitted from the portable device through wireless communication technology.

8. The door access control system according to claim 6, wherein the portable device is operated to make a call to the server, and the server sets a cellphone number of the portable device as the personally identifiable data, or after the portable device is operated to make the call to the server, the personally identifiable data is transmitted to the server through an interactive voice response provided by the server.

9. The door access control system according to claim 6, wherein the server further generates a new authentication barcode corresponding to the personally identifiable data, and the portable device obtains the new authentication barcode.

10. The door access control system according to claim 6, wherein the server further transmits an announcement message to the portable device, and after the server determines that the portable device is turned on and displays the announcement message, the server generates the management signal.
